(19) United States
(12) Patent Application Publication
(10) Pub. No.: US 2005/0264029 A1
(43) Pub. Date: Dec. 1, 2005

(54) Strut and hinge assembly for vehicle

(76) Inventor: Michael E. Bodner, Troy, MI (US)

Correspondence Address: LAURA C. HARGITT;General Motors Corporation, Legal Staff, Mail Code 482-C23-B21, P.O. Box 300, Detroit, MI, 48265-3000, US

(21) Appl. No.: 10/853,429

(22) Filed: May 25, 2004

(51) Int. Cl. B60J 5/10

(52) U.S. Cl. 296/146.8

(57) ABSTRACT

A strut and hinge assembly for a closure of a vehicle includes a hinge adapted to be connected to a vehicle body and a closure for closing an aperture in the vehicle body for allowing rotation therebetween. The strut and hinge assembly also includes a strut to counterbalance a weight of the closure when opening and closing the aperture and having a first end and a second end, the first end being fixed to the hinge. The strut and hinge assembly further includes an actuator connected to the hinge and the second end of the strut to change a position of the second end relative to the hinge depending on whether opening or closing the closure.

### TECHNICAL FIELD

The present invention relates generally to hinges for vehicles and, more particularly, to a strut and hinge assembly for a vehicle.

### BACKGROUND OF THE INVENTION

It is known to provide a closure such as a decklid for a vehicle to open and close a rear compartment or trunk of a vehicle body of the vehicle. Typically, the deck lid is attached to the vehicle body with at least one, preferably a pair of laterally spaced hinges. Currently, the decklid hinges of the free-rise type use a large size goose-neck hinge for counter-balancing a weight of the decklid. However, these goose-neck hinges reduce trunk volume of the rear compartment by 1 to 1.5 cu. ft. This is undesired because trunk volume is a key attribute that purchasers compare when making a vehicle selection.

One attempt to maintain trunk volume and counterbalance the weight of the decklid is to use either pneumatic or hydraulic devices such as a strut. The strut is typically fixed at one end to the decklid and the other end is typically fixed to the vehicle body. However, the opening and closing effort of the decklid changes over time due to the temperature and age of the strut. In addition, the opening and closing effort of the decklid changes with the pitch angle of the vehicle, e.g., when the vehicle is sitting on a hill. Since the ends of the strut are fixed, there is no way to adjust the strut to compensate for these changes.

Therefore, it is desirable to provide a strut and hinge for a closure of a vehicle that adjusts for changes in opening versus closing, temperature, age of the strut, and pitch angle of the vehicle. It is also desirable to provide a strut and hinge for a closure of a vehicle that improves opening and closing efforts of the closure due to changes affecting the strut. Therefore, there is a need in the art to provide a strut and hinge for a vehicle that meets these desires.

### SUMMARY OF THE INVENTION

It is, therefore, one object of the present invention to provide a new strut and hinge assembly for a closure of a vehicle.

It is another object of the present invention to provide a strut and hinge assembly for a closure of a vehicle that improves the opening and closing effort of the closure.

To achieve the foregoing objects, the present invention is a strut and hinge assembly for a closure of a vehicle including a hinge adapted to be connected to a vehicle body and a closure for closing an aperture in the vehicle body for allowing rotation therebetween. The strut and hinge assembly also includes a strut to counterbalance a weight of the closure when opening and closing the aperture and having a first end and a second end, the first end being fixed. The strut and hinge assembly further includes an actuator connected to the second end of the strut to change a position of the second end relative to the hinge depending on whether opening or closing the closure, temperature, age of the strut, or vehicle pitch angle.

One advantage of the present invention is that a new strut and hinge assembly is provided for a closure such as a decklid, liftgate, or door of a vehicle. Another advantage of the present invention is that the strut and hinge assembly improves operator opening and closing efforts for vehicle closures such as decklids, liftgates, and doors on a vehicle. Yet another advantage of the present invention is that the strut and hinge assembly has improved opening and closing efforts based on different strut endpoint positions for opening versus closing, temperature, age, or vehicle pitch angle. Still another advantage of the present invention is that the strut and hinge assembly incorporates a strut with a four bar hinge to combine the compact package size of a four bar hinge with the convenience of improved opening and closing efforts for a door of a vehicle.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a strut and hinge assembly, according to the present invention, illustrated in operational relationship with a vehicle.

FIG. 2 is an elevational view of the strut and hinge assembly of FIG. 1 illustrated in an open operating position.

FIG. 3 is a view similar to FIG. 2 of the strut and hinge assembly illustrated in a closed operating position.

FIG. 4 is an elevational view of another embodiment, according to the present invention, of the strut and hinge assembly illustrated in operational relationship with a vehicle.

FIG. 5 is a plan view of the strut and hinge assembly of FIG. 4 illustrated in a closed operating position.

FIG. 6 is a view similar to FIG. 5 of the strut and hinge assembly illustrated in an open operating position.

### DESCRIPTION OF THE PREFERRED EMBODIMENT

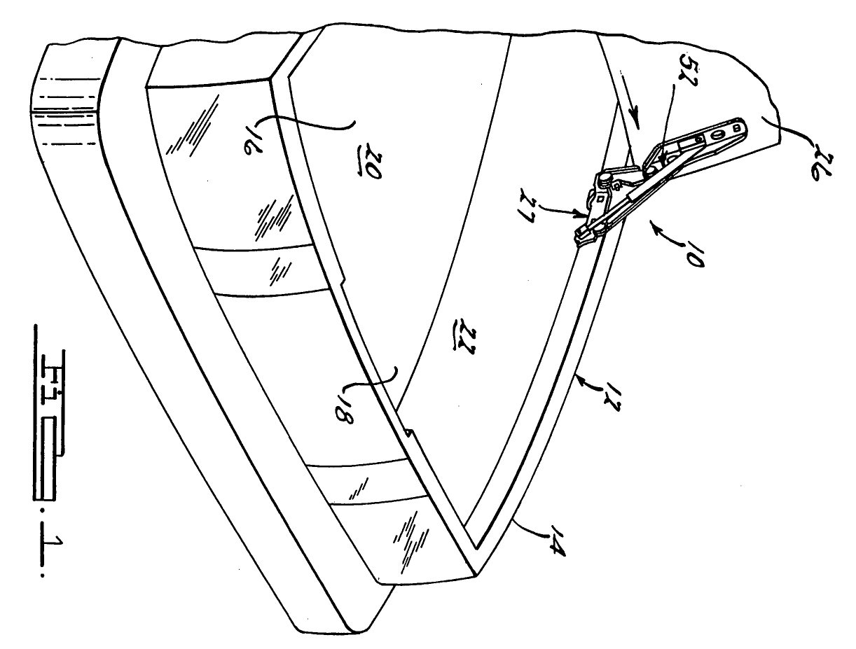

Referring to the drawings and in particular FIG. 1, one embodiment of a strut and hinge assembly 10, according to the present invention, is shown for a vehicle such as a motor vehicle, generally indicated at 12. Such motor vehicles 12 typically include a vehicle body 14 (partially shown) forming a trunk or rear compartment 16. The rear compartment 16 has an opening such as a recess 18 therein. The recess 18 is formed by a floorpan 20 and side walls 22 extending upwardly from the floorpan 20 and generally perpendicular thereto. The vehicle body 14 also includes a closure such as a decklid 26 closing the recess 18. The decklid 26 is attached to the rear compartment 16 of the vehicle body 14 by at least one, preferably a pair of laterally spaced strut and hinge assemblies 10. It should be appreciated that only one strut and hinge assembly 10 is illustrated in FIG. 1 and will be subsequently described. It should also be appreciated that, except for the strut and hinge assembly 10, the vehicle 12 is conventional and known in the art.

Referring to FIG. 2, the strut and hinge assembly 10 includes a hinge, generally indicated at 27, to pivotally connect the decklid 26 to the vehicle body 14. The hinge 27 includes a body side bracket or strap 28 to allow the hinge 27 to be mounted to the vehicle body 14. The body side strap 28 is generally rectangular in shape. The body side strap 28 extends longitudinally and has at least one, preferably a plurality of apertures 30 extending therethrough. The strut and hinge assembly 10 also includes at least one, preferably a plurality of fasteners (not shown) such as bolts to attach the body side strap 28 to the vehicle body 14. Each of the fasteners extends through some of the apertures 30 and corresponding apertures (not shown) in the vehicle body 14 and are engaged by nuts (not shown) to prevent the fasteners from disengaging the apertures 30. It should be appreciated that the fasteners are conventional and known in the art.

The body side strap 28 also includes a projection 32 such as a ball stud extending generally perpendicularly and laterally outwardly at one end thereof for a function to be described. The projection 32 is generally cylindrical or spherical in shape. The body side strap 28 is made of a rigid material such as metal.

The hinge 27 includes a closure side bracket or strap 34 to allow the decklid 26 to be attached to the strut and hinge assembly 10. The closure side strap 34 has a generally inverted “L” shaped cross-section. The closure side strap 34 extends longitudinally and has a base wall 36 and a side wall 38 extending generally perpendicular to the base wall 36. The base wall 36 includes at least one, preferably a plurality of apertures (not shown) extending therethrough. The strut and hinge assembly 10 also includes at least one, preferably a plurality of fasteners (not shown) such as bolts to attach the closure side strap 34 to the decklid 26. Each of the fasteners extend through some of the apertures and corresponding apertures (not shown) in the decklid 26 and are engaged by nuts (not shown) to prevent the fasteners from disengaging the apertures. The closure side strap 34 is made of a rigid material such as metal. It should be appreciated that the fasteners are conventional and known in the art.

The hinge 27 includes a first or short link 40 to allow pivoting action of the strut and hinge assembly 10. The first link 40 extends longitudinally. The first link 40 includes at least one, preferably a plurality of apertures (not shown) extending therethrough. The strut and hinge assembly 10 also includes at least one, preferably a plurality of fasteners 42 to pivotally attach the first link 40 to the closure side strap 34 at a forward end thereof and to the body side strap 28 at a forward end thereof. The first link 40 also includes a flange 44 extending generally perpendicularly and laterally outwardly near one end thereof. The flange 44 may have an aperture (not shown) extending therethrough to receive a fastener 46 such as a bolt that acts as a stop. The first link 40 is made of a rigid material such as metal.

The hinge 27 includes a second or upper link 48 to guide the pivoting action of the hinge 27 along a predetermined path. The second link 48 extends longitudinally. The second link 48 includes at least one, preferably a plurality of apertures (not shown) extending therethrough. The hinge 27 also includes at least one, preferably a plurality of fasteners 50. One of the fasteners 50 is used to attach the second link 48 to the closure side strap 34 at a forward end thereof. Another one of the fasteners 50 is used to attach the second link 48 to a rearward end of the body side strap 28. The second link 48 is made of a rigid material such as metal. It should be appreciated that the fasteners 50 are conventional and known in the art.

The strut and hinge assembly 10 includes a strut, generally indicated at 52, to power the decklid 26 to an open position by applying a force to the hinge 27. The strut 52 is of a gas spring type. The strut 52 includes a reservoir tube 54 that provides a reservoir for a damping fluid. The reservoir tube 54 may be fixed or movable relative to the body side strap 28, the closure side strap 34, or the vehicle body 14. The strut 52 also includes a cylindrical piston rod 56 extending along a central axis of the reservoir tube 54 and is attached at one end to a conventional valved piston (not shown) slidably mounted in the reservoir tube 52. The piston rod 56 may be fixed or movable relative to either the body side strap 28 or the closure side strap 34. In the embodiment illustrated, the piston rod 56 is connected to the body side strap 28 by suitable means such as a connector 58 pressed onto the projection 32. It should be appreciated that the strut 52 applies a force to counterbalance the weight of the decklid 26. It should also be appreciated that the strut 52 may be used with either a single pivot or multi-link hinge.

The strut and hinge assembly 10 includes an actuator 60 to move one end of the strut 52 to change a position or moment arm of a closure side or body side strut endpoint between an open position and a closed position. The actuator 60 is of an electric type to act upon either the first end or the second end of the strut 52. In the embodiment illustrated, the actuator 60 is connected to the closure side strap 34 by suitable means such as a fastener 62. The actuator 60 has an extendable and retractable or moveable member 64 to move the closure side strut endpoint of the strut 52. In the embodiment illustrated, the moveable member 64 is connected to the reservoir tube 54. The actuator 60 may have a guide slot 66 to guide the moveable member 64 in any suitable manner, for example, in a linear manner. The actuator 60 has a force of approximately 600 Newtons to 800 Newtons acting through an angle of about 120 degrees with an actuation range of about 30 to 50 millimeters. In one embodiment, the actuator 60 receives a signal from a switch (not shown) at the full open position and from a switch (not shown) at the full closed position to change the strut endpoint position. In another embodiment, the actuator 60 receives a signal from an electronic controller (not shown). It should be appreciated that the actuator 60 may be attached to the body side strap 28. It should also be appreciated that the actuator 60 may be an electro-mechanical or purely mechanical device. It should further be appreciated that the actuator 60 could act in a linear motion or be on a bell-crank type mechanism.

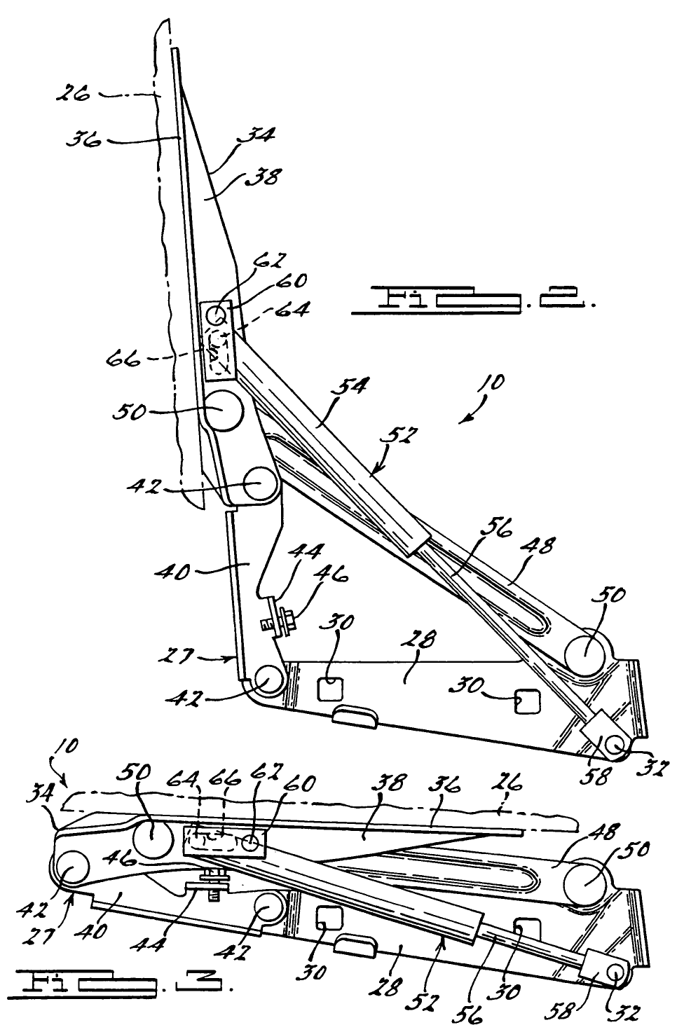

Referring to FIGS. 2 and 3, the strut and hinge assembly 10 is shown in open and closed operating positions, respectively. During opening, the actuator 60 would locate the strut endpoint in such a manner as to increase the moment arm distance from the strut line-of-force to the hinge pivot (or instantaneous center), thereby providing more lift from the strut and reducing the opening effort that an operator must provide. For example, the actuator 60 moves the strut endpoint rearward. During closing, the actuator 60 would reduce the moment arm distance from the strut line-of-force to the pivot (or instant center), thereby reducing the closing effort that the operator must provide. For example, the actuator 60 moves the strut endpoint “forward” relative to the orientation of the closure. At cold temperatures, the actuator 60 moves the strut endpoint rearward. At hot temperatures, the actuator 60 moves the strut endpoint forward. As the strut 52 ages, the actuator 60 moves the strut endpoint rearward. Further, for vehicle pitch angle when the vehicle has its front downward, the actuator 60 moves the strut endpoint forward. It should be appreciated that, if desired, an automatically opening closure could be obtained by providing enough strut force and/or moment arm and a minimum and a minimum hold-open force would be provided to keep the closure open. It should also be appreciated that, with sensors (not shown) and other components (not shown), the strut and hinge assembly 10 could adjust the strut endpoint position in an infinitely variable manner to account for temperature variation (i.e., strut force change due to temperature effect) and time variation (strut force loss due to leakage over time). It should further be appreciated that a controller (not shown) could be connected to the actuator 60 to account for all the above environment factors to position the strut endpoint at the optimum position.

Referring to FIGS. 4 through 6, another embodiment, according to the present invention, of the vehicle and strut and hinge assembly 10 is shown. Like parts have like reference numerals. In this embodiment, the motor vehicle 112 typically includes a vehicle body 114 having at least one opening or aperture 118 in the side thereof. The vehicle body 114 also includes a closure such as a door 126 closing the opening 118. The door 126 is attached to the side of the vehicle body 114 by at least one strut and hinge assemblies 110. It should be appreciated that only one strut and hinge assembly 110 is illustrated in FIG. 4 through 6 and will be subsequently described. It should also be appreciated that, except for the strut and hinge assembly 110, the vehicle 112 is conventional and known in the art.

The strut and hinge assembly 110 includes a hinge 127 to pivotally connect the door 126 to the vehicle body 114. The hinge 127 is of the type disclosed in U.S. Pat. No. 6,382,705 to Lang et al., the disclosure of which is hereby incorporated by reference. The hinge 127 includes a body side bracket or strap 128 to allow the hinge 127 to be mounted to the vehicle body 114. The strut and hinge assembly 110 also includes at least one, preferably a plurality of fasteners (not shown) such as bolts to attach the body side strap 128 to the vehicle body 14.

The hinge 127 includes a closure side bracket or strap 134 to allow the door 126 to be attached to the strut and hinge assembly 110. The strut and hinge assembly 10 also includes at least one, preferably a plurality of fasteners (not shown) such as bolts to attach the closure side strap 134 to the door 126.

The hinge 127 includes a first or outboard link 140 to allow pivoting action of the strut and hinge assembly 110. The strut and hinge assembly 110 also includes at least one, preferably a plurality of fasteners 142 to pivotally attach the first link 140 to the closure side strap 134 and to the body side strap 128.

The hinge 127 includes a second or inboard link 148 to guide the pivoting action of the hinge 127 along a predetermined path. The hinge 127 also includes at least one, preferably a plurality of fasteners 150. One of the fasteners 150 is used to attach the second link 148 to the closure side strap 134 and another one of the fasteners 150 is used to attach the second link 148 to the body side strap 128.

The strut and hinge assembly 10 includes a strut 152 to power the door 126 to an open position by applying a force to the hinge 127. The strut 152 is of a gas spring type. The strut 152 includes a reservoir tube 154 that provides a reservoir for a damping fluid. The reservoir tube 154 may be fixed relative to the body side strap 128, the closure side strap 134, or the vehicle body 14. The strut 152 also includes a cylindrical piston rod 156 extending along a central axis of the reservoir tube 154 and is attached at one end to a conventional valved piston (not shown) slidably mounted in the reservoir tube 152. The piston rod 156 may be fixed or movable relative to either the body side strap 128 or the closure side strap 134. In the embodiment illustrated, the reservoir tube 154 is connected to the closure side strap 134. It should be appreciated that, in one embodiment, the strut 152 is located above or below the link 140 with the strut 152 positioned during opening in such a way as to provide a self-opening force to the door 126, provide a hold-open force at full-open, and during closing to provide a self-closing door. It should also be appreciated that the strut 152 acting on the door 126 through the moment arm distance from the strut line-of-force to the hinge instant center provides a moment on the door 126 which overcomes friction so as to self-open/close the door 126.

The strut and hinge assembly 110 includes an actuator 160 to move one end of the strut 152 to change a position or moment arm of a closure side strut endpoint between an open position and a closed position. The actuator 160 is of an electric type to act upon either the first end or the second end of the strut 152. In the embodiment illustrated, the actuator 160 is connected to the body side strap 128. The actuator 160 has an extendable and retractable or moveable member 164 to move the closure side strut endpoint of the strut 152. In the embodiment illustrated, the moveable member 164 is connected to the piston rod 156. The actuator 160 may have a guide slot 166 to guide the moveable member 164 in a linear manner.

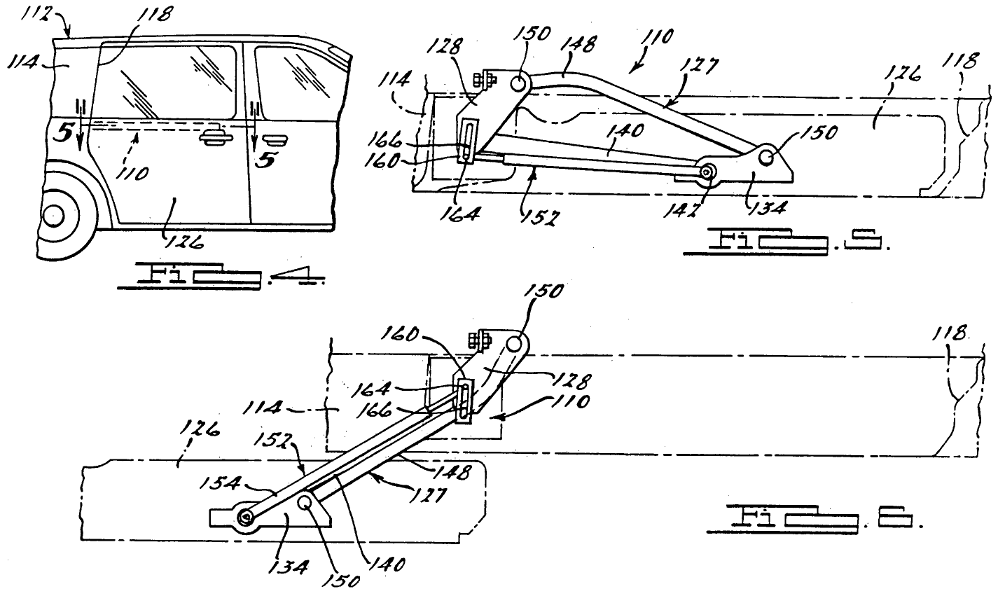

Referring to FIGS. 5 and 6, the strut and hinge assembly 110 is shown in open and closed operating positions, respectively. During opening, the actuator 160 would locate the strut endpoint to provide opening movement by increasing the moment arm distance from the strut line-of-force to the hinge pivot (or instantaneous center), thereby providing self-opening of the door 126. During closing, the actuator 60 would change the moment arm to the other side of the instant center, thereby providing self-closing of the door 126. It should also be appreciated that, with sensors (not shown) and other components (not shown), the strut and hinge assembly 110 could adjust the strut endpoint position in an infinitely variable manner to account for temperature variation (i.e., strut force change due to temperature effect), time variation (strut force loss due to leakage over time), and vehicle pitch attitude. It should further be appreciated that the strut damping would be adjusted to provide a constant, door opening speed (e.g., not too fast).

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A strut and hinge assembly for a closure of a vehicle comprising:
a hinge adapted to be connected to a vehicle body and a closure for closing an aperture in the vehicle body for allowing rotation therebetween;
a strut to counterbalance a weight of the closure when opening and closing the aperture and having a first end and a second end, said first end being fixed; and
an actuator connected to said second end of said strut to change a position of said second end relative to said hinge depending on whether opening or closing the closure, temperature, age of the strut, or vehicle pitch angle.

2. A strut and hinge assembly as set forth in claim 1 wherein said actuator acts in a linear motion.

3. A strut and hinge assembly as set forth in claim 1 wherein said actuator is a bell-crank type mechanism.

4. A strut and hinge assembly as set forth in claim 1 wherein said actuator is of an electric type.

5. A strut and hinge assembly as set forth in claim 1 wherein said actuator has an extendable and retractable member attached to one end of said strut.

6. A strut and hinge assembly as set forth in claim 5 wherein said strut has another end connected to said hinge.

7. A strut and hinge assembly as set forth in claim 1 wherein said strut has a reservoir tube and a movable piston rod extending from said reservoir tube.

8. A strut and hinge assembly as set forth in claim 7 wherein said actuator is connected to either one of said piston rod and said reservoir tube.

9. A strut and hinge assembly as set forth in claim 1 wherein said hinge includes a body side strap adapted to be connected to a vehicle body of the vehicle.

10. A strut and hinge assembly as set forth in claim 9 wherein said hinge includes a closure side strap adapted to be connected to a closure.

11. A strut and hinge assembly as set forth in claim 10 wherein said hinge includes a first link interconnecting said body side strap and said closure side strap for allowing rotation therebetween.

12. A strut and hinge assembly as set forth in claim 11 wherein said hinge includes a second link interconnecting said body side strap and said closure side strap for guiding pivoting action of the hinge along a predefined path.

13. A strut and hinge assembly as set forth in claim 12 wherein said actuator is connected to either one of said body side strap and said closure side strap.

14. A strut and hinge assembly as set forth in claim 13 including fasteners for fastening said first link and said second link to said body side strap and said closure side strap.

15. A closure assembly for a vehicle comprising:
a closure;
a strut and hinge assembly connected to said closure and adapted to be connected to a vehicle body of the vehicle and comprising a hinge, a strut, and an actuator to move one end of said strut relative to said hinge to change a moment arm thereof between an open position and a closed position.

16. A closure assembly as set forth in claim 15 wherein said actuator acts in a linear motion.

17. A closure assembly as set forth in claim 15 wherein said actuator is a bell-crank type mechanism.

18. A closure assembly as set forth in claim 15 wherein said actuator is of an electric type.

19. A closure assembly as set forth in claim 15 wherein said actuator has an extendable and retractable member attached to one end of said strut.

20. A closure assembly as set forth in claim 19 wherein said strut has another end connected to said hinge.

21. A closure assembly as set forth in claim 15 wherein said strut has a reservoir tube and a movable piston rod extending from said reservoir tube.

22. A closure assembly as set forth in claim 21 wherein said actuator is connected to either one of said piston rod and said reservoir tube.

23. A closure assembly as set forth in claim 15 wherein said closure comprises one of a decklid, hatch, or liftgate.

24. A closure assembly as set forth in claim 15 wherein said closure comprises a side door.

25. A vehicle comprising:
a vehicle body having an aperture therein;
a closure for closing said aperture;
a strut and hinge assembly connected to said closure and said vehicle body comprising a hinge, a strut, and an actuator to move one end of said strut relative to said hinge to change a moment arm thereof between an open position and a closed position.
